(19) United States
(12) Patent Application Publication
(10) Pub. No.: US 2011/0153194 A1
(43) Pub. Date: Jun. 23, 2011

(54) NAVIGATIONAL GPS VOICE DIRECTIONS VIA WIRELESSLY DELIVERED DATA AUDIO FILES

(75) Inventor: Garry G. Bellerose, Town of Victor, NY (US)

(73) Assignee: Xerox Corporation

(21) Appl. No.: 12/645,881

(22) Filed: Dec. 23, 2009

(51) Int. Cl. G01C 21/00; H04L 12/58

(52) U.S. Cl. 701/201; 455/412.1

(57) ABSTRACT

A method and system for delivering audio directions to a portable handheld wireless communications device. A portable handheld device can be configured to receive and play data audio files, such as, for example, MP3 audio files. Thereafter, a processor or third party service provider can generate a set of travel plans based on the location of the portable handheld device and the desired destination. The travel plan(s) can be delivered to the portable handheld device as a data audio file, which can then be played through the portable handheld device, thereby providing audio instructions that are related to the set of travel plans.

### TECHNICAL FIELD

Embodiments are generally related to navigational devices and systems such as GPS enabled smart phones, personal digital assistants, and other handheld portable devices with GPS capabilities. Embodiments also relate to the delivery and play back of audio directions on smart phones, personal digital assistants, and other portable handheld devices.

### BACKGROUND OF THE INVENTION

With recent advances in communication technology it has become increasingly common for cellular telephones and other handheld electronic device to come equipped with GPS capabilities. While these advances have provided a significant increase in the capabilities of handheld devices, some of the supporting technology has not kept pace. Note that as utilized herein the acronym GPS generally refers to “Global Positioning Satellite” and/or systems thereof.

For example, although the GPS technology can provide the exact location of a given handheld device, it would be beneficial to have the ability to map out a route in order to take full advantage of the technology. This innovation would prove particularly useful to a user attempting to navigate an automobile. However, to avoid the danger of continuously looking away from the road to look at the route information being provided on the display of the handheld device, it is much more convenient and safe to have the route information communicated to the driver as audio instructions. It must be noted with nearly equal importance that providing these same loud and clear audible directions is very relevant to a Pedestrian also using the application on a hand-held wireless device.

Several companies provide a service where a GPS-enabled handheld device can send the location of the device and the target destination to a third party service provider who in turn develops an optimal route and provides that information to the handheld device. The directions provided to the handheld device are generally either manifested strictly as map based directions with text instructions provided on the display screen, which requires the user to concentrate on the handheld device instead of the road, or as an Adaptive Multi-Rate (AMR) audio transmission.

AMR technology is common method of audio data compression used for speech coding. AMR technology is a widely used file compression method for the transmission of audio files to cellular telephones and other similar handheld devices. The current cell industry standard is to deliver navigational voice directions using the telephone AMR side of a handheld device. However, AMR technology has proven to be very poor for transmitting optimal route data as described above. This is because the AMR compressed audio directions are nearly incomprehensible due to the poor quality of the voice rendering.

As such there is a need for an improved method and system for the delivery of audio data files containing GPS related audio directions. As smart phones, PDA's and other such hand held devices improve in their technical capabilities a solution may be found by providing the audio directions as MP3 audio files. The use of streaming MP3 data audio files ensures that the full sound output capabilities of the newest multimedia wireless handheld communications devices are realized when delivering spoken voice direction from the resident GPS navigational application loaded onto those devices.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide an improved GPS enabled handheld wireless communications device.

It is another aspect of the disclosed embodiments to provide a system and method for providing improved delivery of GPS navigational directions audio data files to handheld wireless communications devices.

The aforementioned aspects and other objectives and advantages can now be achieved as described herein. A method and system is disclosed for communicating audio directions to a portable handheld wireless communications device. In general, a portable handheld wireless communications device can be configured to receive and play data audio files. Thereafter, a processor can generate a set of travel plans based on the location of the portable handheld device and the desired destination. That travel plan can be delivered to the portable handheld device as a data audio file, which can then be played through the portable handheld device thereby providing audio instructions, related to the set of travel plans.

Additionally, the portable handheld wireless communications device can be configured with a GPS capability. The portable handheld device can provide its exact location to a third party service provider along with a desired destination. The third party service provider can then develop a set of travel plans and transmit those planes to the portable handheld device as a streaming data audio file.

The portable handheld wireless communications device may be configured as a cellular telephone, a smartphone, or a personal digital assistant. The streaming data audio file transmitted to the portable handheld device may comprise an MP3 audio file.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a system for communicating audio directions, in accordance with a preferred embodiment;

FIG. 2 illustrates a front view of a GPS enabled cellular telephone, in accordance with an preferred embodiment;

FIG. 3 illustrates a front view of a smart phone or personal digital assistant, in accordance with a preferred embodiment;

FIG. 4 illustrates a block diagram of a portable handheld wireless communications device, in accordance with a preferred embodiment; and

FIG. 5 illustrates a high level flow chart of a system for communicating audio directions to a GPS enabled portable handheld wireless communications device, in accordance with a preferred embodiment.

### DETAILED DESCRIPTION

The particular values and configurations discussed in these non-limiting examples can be varied and are cited merely to illustrate at least one embodiment and are not intended to limit the scope thereof.

Some of the embodiments described herein can be implemented in the context of a host operating system and one or more modules. Such modules may constitute hardware modules, such as, for example, electronic components of a computer system. Such modules may also constitute software modules. In the computer programming arts, a software “module” can be typically implemented as a collection of routines and data structures that performs particular tasks or implements a particular abstract data type.

Software modules generally include instruction media storable within a memory location of a data-processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term “module” as utilized herein can therefore generally refer to software modules or implementations thereof. Such modules can be utilized separately or together to form a program product that can be implemented through signal-bearing media, including transmission media and recordable media.

It is important to note that, although the embodiments are described in the context of a fully functional data-processing apparatus (e.g., a computer system, cellular telephone, smartphone, or personal digital assistant), those skilled in the art will appreciate that the mechanisms of the embodiments are capable of being distributed as a program product in a variety of forms.

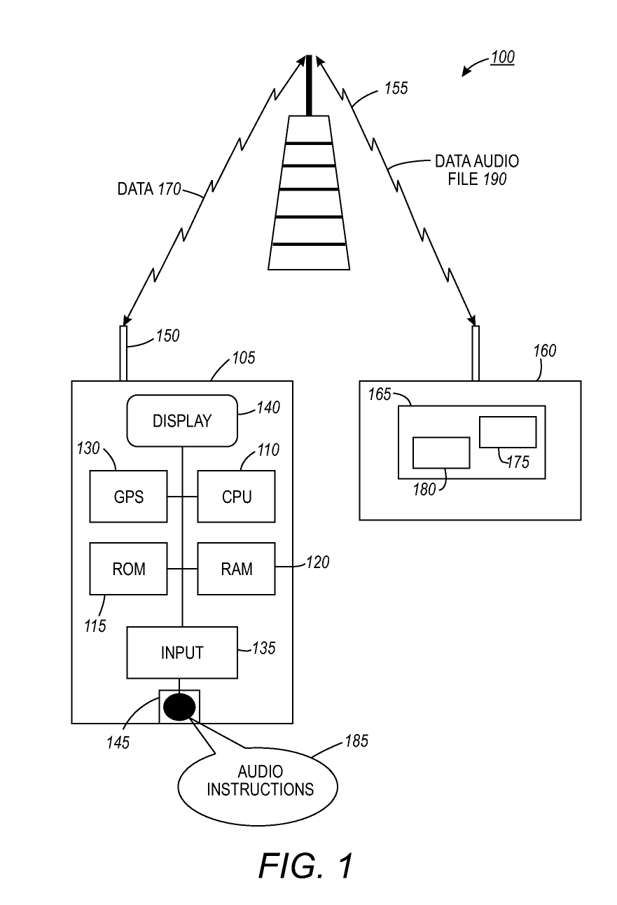

Referring to the drawings and in particular to FIG. 1, there is depicted a system 100 for communicating audio directions in accordance with a preferred embodiment. As shown in FIG. 1, a portable handheld device 105 can be configured with a processor (CPU) 110, a Read-Only memory (ROM) 115, and a Random-Access Memory (RAM) 120 which are generally connected to a system bus 125 of the portable handheld device 105. Portable handheld device 105 can also be equipped with a GPS capability 130, a user input device 135, a display 140, a loudspeaker 145, and a RF transceiver 150 for providing connection to a wireless network 155. The user input device 135, GPS capability 130, display 140 and loudspeaker 145 are also connected to and communicate with system bus 125. Portable handheld device 105 can generally be embodied as a cellular telephone, smartphone, personal digital assistant, or any other such GPS enabled handheld wireless communications device.

Portable handheld wireless communications device 105 can be configured to receive and play audio data files. These files can be received by the portable handheld device 105 and transmitted by the portable handheld device 105 via a high speed, high bandwidth wireless network 155. A preferred embodiment can make use of a wireless network capable of transferring larger quantities of data at high speeds.

One example of such a wireless network 155 is the International Mobile Telecommunications-2000, also known as 3G (3^{rd} Generation). This family of services includes wide-area wireless, voice telephone, and wireless data transfer in a mobile environment. Users of a 3G network can expect minimum data transmission rates between 300 kilobits per second and 2 megabits per second depending on the users traveling speed. While 3G represents a present industry standard for high speed wireless communication, one skilled in the art will appreciate the present invention can take advantage of technological advances as the speed and bandwidth of wireless networks increase. In some embodiments, network 155 can be implemented as a 4G (4^{th} Generation) network, which includes high-speed high-bandwidth wireless communications.

In FIG. 1, portable handheld device 105 is transmitting data 170 related to position and intended destination to a third party service provider 160 via high-speed high bandwidth wireless network 155. In a preferred embodiment third party service provider 160 determines a travel plan based on this data using a computer 165 equipped with a processor 180 and software 176 intended to determine a best travel plan. After the third party service provider 160 has determined a preferred travel plan based on the transmitted device location and desired destination data 170, the third party service provider 160 delivers the travel plan to the portable handheld device as a data audio file 190 via the high speed high bandwidth wireless network 155.

Once the travel plans have been transmitted to the portable handheld device 105 as a data audio file, the file is played as audio instructions 185. The preferred embodiment described allows a user of the handheld device to receive audio instructions 185, which communicate the travel plans provided as data audio file 190, without the hazard of having to look at portable handheld device 105 while, for example, operating a motor vehicle.

In a preferred embodiment of the present invention the data audio file 190 transmitted to the portable handheld device 105 is a MP3 file. MP3 is a digital audio encoding format using lossy data compression. MP3 files are an audio specific format designed to reduce file size while retaining audio quality. The use of MP3 audio files in accordance with a preferred embodiment of the invention represents a significant improvement over the state of the art which includes the use of Adaptive Multi-Rate (AMR) audio compression. While AMR compressed files may be smaller than comparable MP3 files, field tests of audio directions produced using AMR compression have proved nearly incomprehensible because of the comparatively low quality of the sound produced compared to the same human speech processed and reproduced by using MP3 audio files for playback.

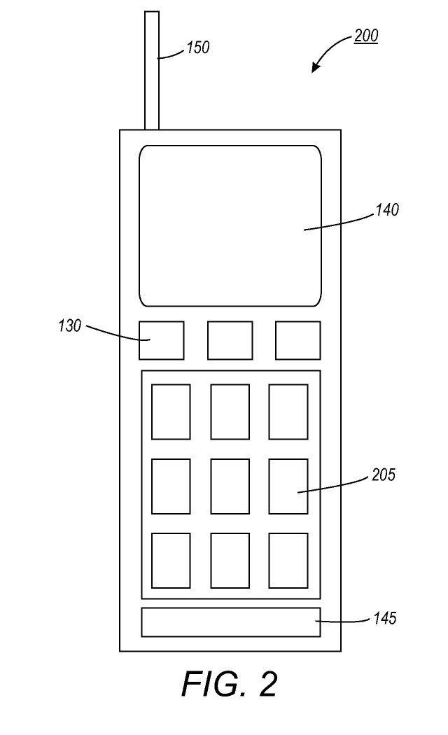

Referring to FIG. 2, a front view of a GPS enabled cellular telephone 200, in accordance with a preferred embodiment is shown. Notice that shared components between FIG. 1 and FIG. 2 are labeled with the same reference numbers. A cellular telephone 200, may generally serve as the portable handheld device shown in FIG. 1. Cellular telephone 200 can include, for example, a GPS module 130, a user input device embodied as a key pad 205, a display 140, a loudspeaker 145, and a RF transceiver 150 for providing connection to a wireless network. Note that the RF transceiver 150 can be implemented in some embodiments as individual receiver and transmitter components.

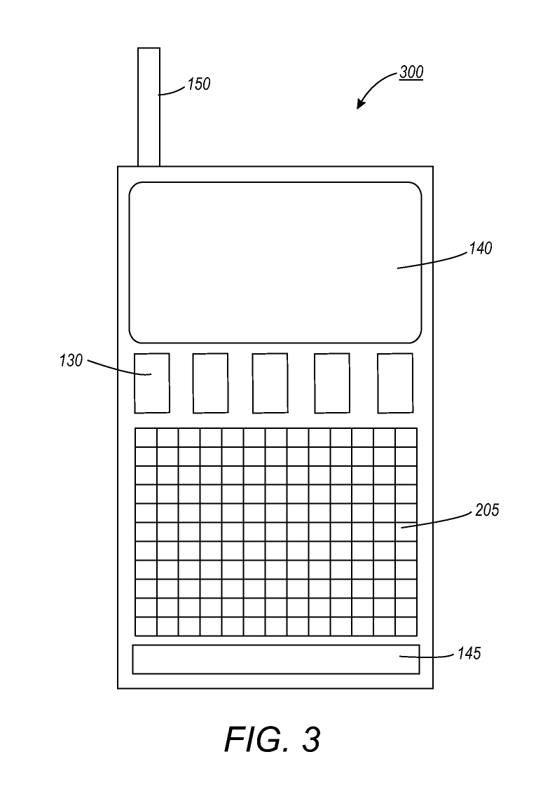

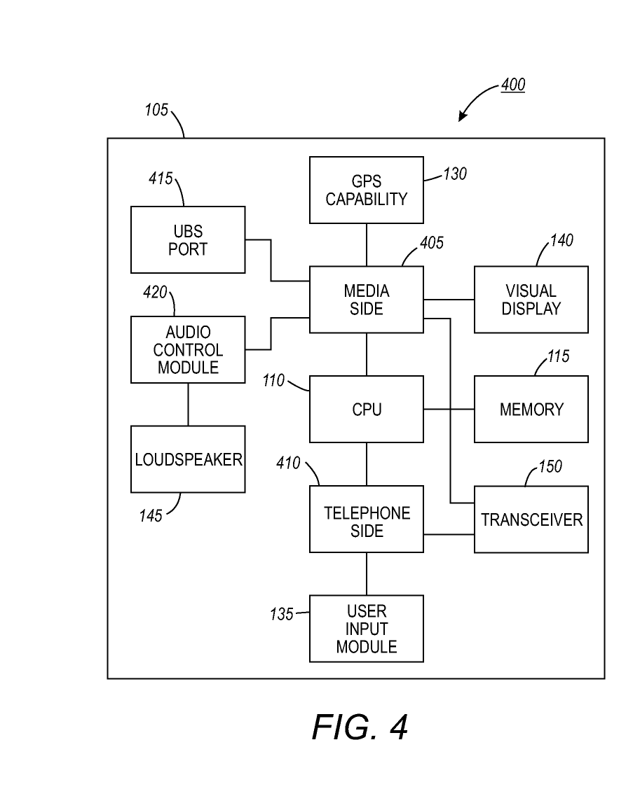

Referring to FIG. 3, a front view of a GPS enabled Smartphone and/or PDS (Personal Digital Assistant) 300 is shown. As in FIG. 1 and FIG. 2, the configuration of FIG. 3 can include a GPS module 130, a user input device herein embodied as a keyboard 305, a display 140, a loudspeaker 145, and a RF transceiver 150 for providing connection to a wireless network. Generally, a PDA (Personal Digital Assistant) and/or Smartphone can be equipped with an internal computing function as shown in the preferred embodiment of FIG. 4. In addition, a Smartphone is generally equipped with an operating system module (not shown) which enables a user to access features like e-mail, the internet, and other web based applications. One skilled in the art will recognize that a smartphone and PDA are essentially equivalent devices and that the description of a device as a Smartphone or a PDA may be used interchangeably.

Referring to FIG. 4, a block diagram 400 of a portable handheld device 105 is shown. In a preferred embodiment portable handheld device 105 is equipped with a central processing unit 110 (CPU) connected to a media side 405 and to a telephone side 410. As one skilled in the art will appreciate, with advancements in the portable handheld device art, such devices are now configured to function both as a telephone and as a portable media unit.

Media audio side 405 is connected to a visual display 140, a GPS capability 130, a universal serial bus (USB) port 415, and an Audio control module 420. The travel plan developed by the third party service provider can be delivered to the media audio side 405 of the portable handheld device 105 via transceiver 150. The data audio file 190 is, in a preferred embodiment, delivered to the media audio side 405 of the portable handheld device. In addition, in a preferred embodiment, the media audio side is equipped to receive and play MP3 audio files via a loud speaker 145.

The telephone side 410 of the portable handheld device 105 is connected to transceiver 150 and is preferably used to allow the handheld device to function as a telephone.

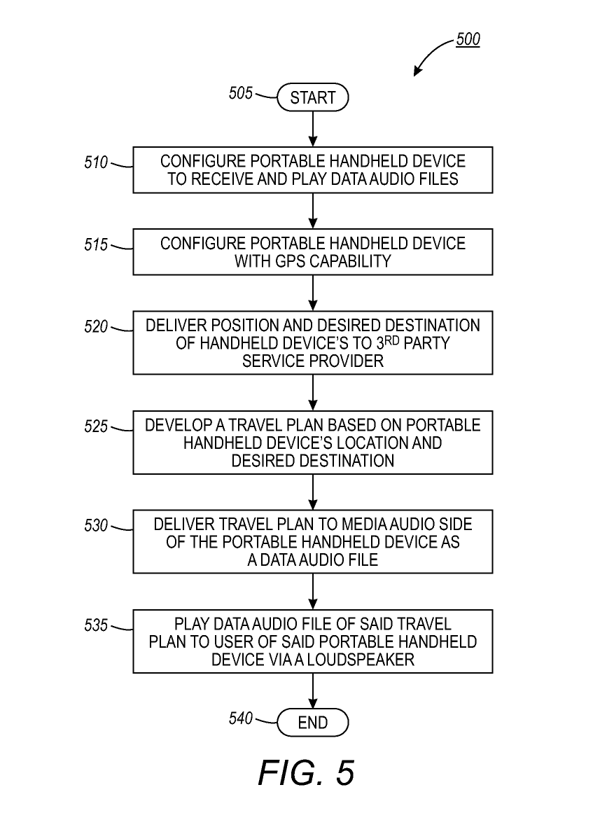

Referring to FIG. 5, a high level flow chart of a system for communicating audio directions 500 to a GPS enabled portable handheld wireless communications device, in accordance with a preferred embodiment is shown. The method starts as indicated at block 505. At block 510 a portable handheld device is configured to received and play data audio files. In a preferred embodiment the data audio files referenced are MP3 audio files. In addition as shown at block 515, the device is also configured with a GPS capability.

Thereafter at block 520, the position of the device along with a desired destination is provided to a third party service provider. In a preferred embodiment, the position of the device is determined using the GPS capability associated with the device. Block 525 shows that the third party service provider then develops a travel plan based on the position and desired destination provided.

After the travel plan has been developed at block 525, the travel plan is delivered to the media audio side of the portable handheld device as a data audio file as shown at block 530. In a preferred embodiment the audio data file is transmitted over a high speed high bandwidth wireless network as an MP3 audio file.

As indicated at block 535, the data audio file is then played through a loudspeaker associated with the portable handheld device, thereby providing audio directions associated with the travel plan. The method then ends, as indicated at block 540.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for communicating audio directions, said system comprising:
a portable handheld device for receiving and playing at least one data audio file;
a processor for generating a set of travel plans based on a location of a portable handheld wireless communications device and a desired destination, wherein said set of travel plans is deliverable to a media audio side of said portable handheld device as said at least one data audio file and wherein said data audio file is playable through said media audio side of said portable handheld device in order to provide audio instructions related to said set of travel plans via said portable handheld device.

2. The system of claim 1 wherein said portable handheld device is configured with a GPS capability.

3. The system of claim 2 wherein said portable handheld device transmits said location of said portable handheld device based on said GPS capability to a third party service provider.

4. The system of claim 1 wherein said portable handheld device comprises a cellular telephone.

5. The system of claim 4 wherein said cellular telephone comprises a smartphone.

6. The system of claim 4 wherein said cellular telephone comprises a PDA.

7. The system of claim 1 wherein said location of said portable handheld wireless communications device is provided to a third party service provider to permit said third party service provider to develop said set of travel plans and transmit said set of travel plans to said portable handheld device as said at least one data audio file.

8. The system of claim 1 wherein said at least one data audio file comprises an MP3 audio file.

9. A method for providing audio directions, said method comprising:
providing a portable handheld device for receiving and playing data audio files;
generating a travel plan based on a location of said portable handheld device and a desired destination;
delivering said travel plan to a media audio side of said portable handheld device as at least one data audio file; and
playing said at least one data audio file through said media audio side of said portable handheld device to provide audio directions associated with said travel plan.

10. The method of claim 9 wherein said portable handheld device is configured with a GPS capability.

11. The method of claim 10 wherein said portable handheld device transmits said location of said portable handheld device based on said GPS capability to a third party service provider.

12. The method of claim 10, wherein said portable handheld device comprises a cellular telephone.

13. The method of claim 12, wherein said cellular telephone comprises a smartphone.

14. The method of claim 12, wherein said cellular telephone comprises a personal digital assistant (PDA).

15. The method of claim 11 said method further comprising:
providing said location of said portable handheld device to said third party service provider wherein said third party service provider develops said set of travel plans and transmits said set of travel plans to said media audio side of said portable handheld device as said at least one data audio file.

16. The method of claim 9 wherein said at least one data audio file comprises an MP3 audio file.

17. A method for providing audio directions, said method comprising:
providing a portable handheld device for receiving and playing data audio files;
configuring said audio device with a GPS capability;
providing a location of said portable handheld device, based on said GPS capability, and a desired destination to a third party service provider.
said third party service provider generating a travel plan based on said location of said portable handheld device and said desired destination;
said third party service provider delivering said travel plan to a media audio side of said portable handheld device as at least one data audio MP3 file; and
playing said at least one data audio MP3 file through said media audio side of said portable handheld device to provide audio directions associated with said travel plan.

18. The method of claim 18, wherein said portable handheld wireless communications device comprises at least one of the following:
a personal digital assistant;
a smart phone; or
a cellular telephone.

19. The method of claim 17, said method further comprising:
delivering said travel plan generated by said third party service provider to said media audio side of said portable handheld device over a high bandwidth wireless network.

20. The method of claim 17, said method further comprising:
configuring said portable handheld device with a loud speaker associated with said media audio side of said portable handheld device; and
routing said data audio MP3 file through said media audio side of said portable handheld wireless communications device so that said audio directions are played through said loudspeaker.
